(19) United States
(12) Patent Application Publication
(10) Pub. No.: US 2025/0289184 A1
(43) Pub. Date: Sep. 18, 2025

(54) DOSING DEVICE, ADDITIVE MANUFACTURING DEVICE AND DOSING METHOD

(71) Applicant: TRUMPF Laser- und Systemtechnik SE, Ditzingen (DE)

(72) Inventor: Tim Geisler, Brackenheim (DE)

(21) Appl. No.: 19/224,937

(22) Filed: Jun. 2, 2025

Related U.S. Application Data
(63) Continuation of application No. PCT/EP2023/083178, filed on Nov. 27, 2023.

(30) Foreign Application Priority Data
Dec. 7, 2022 (DE) 10 2022 132 460.5

(51) Int. Cl. B29C 64/343; B29C 64/205; B33Y 30/00; B33Y 40/00

(52) U.S. Cl. CPC B29C 64/343; B29C 64/205; B33Y 30/00; B33Y 40/00

(57) ABSTRACT

A dosing device is for arrangement on the outside of a process chamber of an additive manufacturing device and for conveying process powder into the process chamber. The dosing device includes at least one powder container including at least one powder cavity which is designed to receive the process powder; and a container guide for moving the powder container in a straight line along a conveying axis of the dosing device. The powder container is movably arranged on the container guide, and the powder container is designed to be deflected beyond the container guide along the conveying axis.

### CROSS REFERENCE TO RELATED APPLICATIONS

This application is a continuation of International Application No. PCT/EP2023/083178 (WO 2024/120873 A1), filed on Nov. 27, 2023, and claims benefit to German Patent Application No. DE 10 2022 132 460.5, filed on Dec. 7, 2022. The aforementioned applications are hereby incorporated by reference herein.

### FIELD

The invention relates to a dosing device for process powder. The invention furthermore relates to an additive manufacturing device and a dosing method.

### BACKGROUND

Dosing devices are typically used on additive manufacturing devices that are designed to manufacture workpieces from the process powder. The dosing device is used, among other things, to feed the process powder to a process chamber of the additive manufacturing device.

Typically, coaters are used within the process chamber of the additive manufacturing device, which distribute the process powder in a working cylinder. In order to enable the process powder to be distributed or “laid out” quickly and in a uniform manner, the dosing device has the task of supplying the process powder to the coater in as precisely pre-dosed a manner as possible.

A common type of device for conveying process powder into the process chamber involves feeding the required process powder to the coater from below using a lifting device. However, this requires a considerable amount of space beneath the process chamber.

In addition to a powder feed from below, other types of dosing devices are known from the prior art.

EP 2 191 922 A1 describes a powder application device with two separate powder chambers. Each powder chamber has a conveying shaft with multiple recesses, which conveys a powder in the powder chamber in the direction of the powder outlet opening. The powder chambers are designed to be carried along on the coater.

DE 10 2020 129 420 A1 describes a coating device with multiple receptacles, wherein the receptacles are filled from above by means of a dosing device under the influence of gravity.

The dosing devices known from the prior art are arranged inside the process chamber in order to be able to supply the required process powder directly to the coater. However, this means that larger internal dimensions must be provided with respect to the process chamber, which increases the volume of the process chamber. As an additive manufacturing method is carried out under inert conditions, this increases the effort required to inert the process chamber.

In addition, the dosing devices arranged inside of the process chamber constitute a flow obstacle for the shielding gas flow formed in the process chamber. This can lead to undesirable flow turbulence within the process chamber, which can cause the process powder to swirl up.

### SUMMARY

In an embodiment, the present disclosure provides a dosing device for being arranged on the outside of a process chamber of an additive manufacturing device and for conveying process powder into the process chamber. The dosing device includes at least one powder container including at least one powder cavity which is designed to receive the process powder; and a container guide for moving the powder container in a straight line along a conveying axis of the dosing device. The powder container is movably arranged on the container guide, and the powder container is designed to be deflected beyond the container guide along the conveying axis.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of an additive manufacturing device with a process chamber and a powder coater according to an embodiment of the present invention;

FIG. 2 shows the additive manufacturing device from FIG. 1 in a rear view of the process chamber with a dosing device according to an embodiment of the present invention;

FIG. 3 shows the additive manufacturing device from FIG. 1 with the powder container of the dosing device received in a discharge channel according to an embodiment of the present invention;

FIG. 4 shows a detailed view of the powder coater with the powder containers of the dosing device arranged therein according to an embodiment of the present invention;

FIG. 5 shows a further detailed view of the powder coater from FIG. 4 in a sectional view according to an embodiment of the present invention;

FIG. 6 shows a detailed sectional view of the dosing device from the previous figures according to an embodiment of the present invention;

FIG. 7 shows a detailed view of a further embodiment of a dosing device according to an embodiment of the present invention; and

FIG. 8 shows a schematic representation of the dosing method according to an embodiment of the present invention.

### DETAILED DESCRIPTION

Embodiments of the present invention can provide a dosing device in which a process chamber volume can be kept low and a low-turbulence shielding gas flow can be ensured. Embodiments of the present invention further provide an additive manufacturing device and a dosing method.

According to an embodiment of the present invention, a dosing device is provided. The dosing device is designed for being arranged on the outside of a process chamber of an additive manufacturing device. Furthermore, the dosing device is suitable, in particular designed, for conveying process powder into the process chamber of the additive manufacturing device.

A process powder is understood to be a working medium, in particular of an additive manufacturing device, in powder form. In other words, the process powder is used to create a workpiece. A workpiece can be produced from various process powders, such as aluminum, silicon, magnesium, corundum or titanium. This list is not intended to be exhaustive. The various process powders can differ, for example, by a powder particle size of the process powder, a powder material, in particular a mixture of different powder materials, and/or a powder color. For example, an aluminum-silicon-magnesium alloy can be used.

The dosing device has at least one powder container. In a preferred embodiment, the dosing device has two or more powder containers. The powder container can have a powder container length that is formed predominantly along a conveying axis of the dosing device. The powder container length is, in a preferred embodiment, adapted to a powder coater width of the powder coater. The powder container length can be between 50 millimeters and 1200 millimeters, for example.

The at least one powder container has at least one powder cavity. The powder cavity is designed to receive and/or dispense the process powder. In other words, the powder container can store process powder.

The dosing device furthermore has a container guide. The container guide is designed for moving the powder container in a straight line. Typically, the powder container is designed to be guided along the conveying axis of the dosing device.

In a specific embodiment of the present invention, the dosing device can have a guide carriage. The at least one powder container can be arranged, in particular mounted, on the guide carriage. The guide carriage can be arranged on the container guide such that it can be moved in a translational manner.

In a preferred embodiment, the guide carriage has a container holder. The container holder can be formed along the conveying axis. Typically, the container holder is designed to hold or support the powder container. In a preferred embodiment, the container holder is designed to hold or support all powder containers of the dosing device. This can prevent the powder container from bending, in particular if the powder container has extended dimensions along the conveying axis.

The container guide, in a preferred embodiment, has a guide end that can be arranged on the process chamber. In other words, in a state of the dosing device arranged on the process chamber, the container guide extends up to an outer side of the process chamber. This allows the dosing device to be mounted on the process chamber and for a guide length of the container guide to be designed to be as long as possible.

According to an embodiment of the present invention, the powder container is movably arranged on the container guide. The powder container is designed to be moved or deflected beyond the container guide along the conveying axis. In other words, the powder container can be pushed beyond the guide end. The dosing device can consequently be extended in a push-out manner in order to introduce the powder container into the process chamber, for example via a process chamber opening.

In summary, an embodiment of the dosing device according to the present invention is designed to be arranged outside of a process chamber on an additive manufacturing device. In order to be able to convey the required process powder into the process chamber during the manufacture of a workpiece within the additive manufacturing device, the dosing device is designed to be linearly movable. The powder container can thus be fed into the process chamber from outside of the process chamber in order to supply the required process powder. In other words, only a part of the dosing device is moved into the process chamber for a short period of time in order to supply the process powder. The process chamber can therefore have particularly small dimensions. Furthermore, the dosing device can be moved out of the process chamber during manufacture, ensuring a turbulence-free flow of shielding gas.

In a preferred embodiment, the dosing device has a longitudinal drive. The longitudinal drive is typically designed to move the powder container along the conveying axis. The longitudinal drive can be driven hydraulically, pneumatically and/or electrically, for example. In a preferred embodiment, the longitudinal drive is designed as a belt drive. By means of a longitudinal drive, the powder container can be moved in a particularly precise and controlled manner, which means that the supply of the process powder can be precisely matched to a manufacturing method in the process chamber. The longitudinal drive is, in a preferred embodiment, arranged or mounted on the guide carriage. In a particularly preferable embodiment, the longitudinal drive moves along with the guide carriage. This allows the drive and the dosing device to be kept compact.

Further preferred is an embodiment of the dosing device in which the powder cavity has at least one vertically upwardly directed powder opening. Typically, the number of powder openings is equal to the number of powder cavities in the powder container. In a preferred embodiment, each powder cavity has exactly one powder opening. Furthermore, the powder cavity of a powder container can be divided into two or more segments by means of separators. In this regard, these segments can be distributed evenly and/or unevenly across the powder cavity. The division into segments supports a uniform distribution of the powder over the length of the powder cavity. This is particularly advantageous for long powder cavities. Furthermore, the division of the powder cavity into segments ensures that when the powder container is moved, the powder is only moved within the segments and thus the uniform distribution is essentially maintained. The vertically upwardly directed powder opening allows the powder cavity or powder container to be filled in the direction of gravity. This means that the powder container can be filled without special or complex technical means.

In a preferred embodiment of the dosing device, the powder container is arranged on the container guide in a manner rotatable about a container rotation axis. In other words, the powder container is designed to be rotatable relative to the container guide. In a preferred embodiment, the rotation axis is aligned with a movement axis of a powder coater of the additive manufacturing device and/or the conveying axis of the dosing device. For example, the powder container can be designed to rotate about a rotation axis running perpendicular to the conveying axis. This can be particularly advantageous if the conveying axis of the dosing device is formed as parallel to the direction of movement of the powder coater. Due to the rotatable design of the powder container, the powder opening of the powder cavity can be moved or rotated from a vertically upwardly directed position to a vertically downwardly directed position. The powder container filled with process powder can be emptied in the vertically downwardly directed position of the powder opening under the influence of gravity. This eliminates the need for an additional powder opening, among other things.

A preferred further development of the dosing device is one in which the container rotation axis is designed to be parallel or congruent to the conveying axis. In other words, the powder container can be designed to be rotated about a conveying direction. This is particularly advantageous if the conveying direction is designed as perpendicular to the direction of movement of the powder coater, or if the powder is fed to the powder coater from the side. In this manner, the process powder can be fed parallel to the conveying axis in front of the powder coater, which simplifies the subsequent distribution by the powder coater.

In a particularly preferred further development of an embodiment of the present invention, the dosing device has a rotary drive. The rotary drive is typically designed to rotate the powder container about the container rotation axis. The rotary drive can be driven hydraulically, pneumatically and/or electrically, for example. For example, the rotary drive can be designed as an electric stepper motor. In a preferred embodiment, the rotary drive is designed as a pneumatic rotary actuator. The powder feed can be carried out mechanically, in particular automatically, by means of a rotary drive. The rotary drive is, in a preferred embodiment, arranged or mounted on the guide carriage. In a preferred embodiment, the rotary drive is moved along with the guide carriage. This allows the dosing device to be kept even more compact.

In a preferred embodiment, a single rotary drive is designed to rotate all powder containers. For this purpose, the rotary drive can have a gear, for example a pinion and/or a belt, via which the powder containers are coupled together. The rotary drive is, in a preferred embodiment, designed to rotate the powder containers individually, in particular independently of one another. This allows the powder containers to be filled, conveyed and/or emptied particularly efficiently.

In a preferred embodiment of the dosing device, the at least one powder container is designed as a shaft. In other words, the powder container has a substantially cylindrical outer geometry. This allows the powder container to be designed to be particularly rigid. Furthermore, the container cross-section can be kept small in relation to the shaft volume. This favors the design of a process chamber opening with a small cross-section at the process chamber. This allows the process chamber opening to be closed with technically simple sealing means. In particular, the powder container is designed as a hollow shaft. This allows the weight of the powder container to be kept to a minimum. In a preferred embodiment, the interior of the hollow shaft forms the powder cavity in this case.

In a preferred embodiment, the dosing device comprises a weighing unit. The weighing unit is typically designed to determine the amount of process powder contained in the powder container. For example, the entire dosing device can be weighed using the weighing unit. The process powder contained in the powder container can be further determined, for example, by forming a difference between a weight of the dosing device before filling and a weight of the dosing device after or during filling. By determining the process powder contained in the powder container, a dosage of the process powder can be precisely matched to the powder quantity required in the process chamber. This can prevent overdosing and/or underdosing of the process powder.

In a preferred further development of the dosing device, the weighing unit has at least one measuring sensor. The measuring sensor is, in the preferred embodiment, designed to weigh the powder container. In a preferred embodiment, the dosing device has at least two measuring sensors. In a particularly preferred embodiment, the dosing device has two measuring sensors per powder container. The measuring sensors are typically arranged at opposite ends of the respective powder container to be measured. Weighing the powder container can increase the accuracy with respect to determining the process powder contained in the powder container, as this does not include the total mass of the dosing device.

A further development of an embodiment of the dosing device is particularly preferred, in which the measuring sensor is designed for temporary arrangement on the test container. In other words, the measuring sensor is only arranged on the powder container to measure the powder container weight. If no measurement is conducted, the measuring sensor is arranged at a distance from the test container. This can prevent the test container and/or the guide carriage from colliding with the weighing unit. Typically, the measuring sensor is designed to be arranged in the vertical direction. This allows the measuring sensor to be positioned against the influence of gravity on the test container.

In a preferred embodiment, the measuring sensor is arranged on the test container by means of an actuator. An actuator can further increase the degree of machine automation.

The dosing device can provide that the test container is designed to be deflectable in the vertical direction from a storage position. In other words, the test container is supported by a vertical floating bearing. In this case, the powder container can be lifted by the weighing unit in order to measure the powder container weight. In a preferred embodiment, the test container is designed to be lifted by 0.5 millimeters or more, particularly preferably by 1 millimeter or more. This allows only the weight of the powder container to act on the measuring sensors in an advantageous manner, which means that the weight of the powder container can be measured even more accurately.

In a preferred embodiment, the dosing device has at least two powder containers, each having at least one powder cavity. The powder containers can be arranged parallel to one another.

A preferred further development of an embodiment of the dosing device is one in which the powder containers are designed to move together, in particular synchronously, along the container guide or conveying axis. This allows two powder containers to be fed into the process chamber at the same time.

The underlying advantages are further achieved by an additive manufacturing device. The additive manufacturing device is typically suitable, in particular designed, for the manufacture of at least one workpiece in layers from the process powder by means of region-by-region solidification of the process powder in the process chamber.

The additive manufacturing device has at least one dosing device described above and below. The additive manufacturing device can have two or more dosing devices described above and below.

The additive manufacturing device has at least one process chamber. The process chamber is typically designed to manufacture workpieces from the process powder. The process chamber has at least one closable process chamber opening. In other words, the process chamber has an access that can be opened. The process chamber opening can be predominantly closed in order to minimize the penetration of ambient gases into the process chamber.

According to an embodiment of the present invention, the dosing device is arranged, in particular mounted, on the outer side of the process chamber. In a preferred embodiment, the guide end of the container guide is arranged, in particular mounted, on the outer side of the process chamber. In other words, the container guide ends directly at a process chamber wall.

The dosing device is designed to move the powder container along the conveying axis through the closable process chamber opening into the process chamber. The process chamber opening can be opened for this purpose. In a preferred embodiment, the dosing device is arranged on the process chamber in such a manner that the dosing device closes the process chamber opening. In a particularly preferrable embodiment, the powder container of the dosing device closes the process chamber opening. In this case, the process chamber opening can be opened advantageously by moving the powder container.

In a preferred embodiment, the additive manufacturing device has a working cylinder arranged in the process chamber. The workpiece to be manufactured is usually manufactured in the process chamber within the working cylinder. The additive manufacturing device can have multiple working cylinders. This can facilitate the simultaneous manufacture of multiple workpieces.

In a preferred embodiment, in connection with multiple dosing devices, the additive manufacturing device has at least one dosing device on opposite sides of the working cylinder. This allows the process powder to be fed into the process chamber at multiple points, allowing for an even more effective dosing.

According to an embodiment of the present invention, the additive manufacturing device also has a powder coater for distributing the process powder in the working cylinder. The powder coater is typically designed to be movable along the coater axis above the working cylinder. In a preferred embodiment, the coater axis runs perpendicular to the conveying axis of the dosing device. This allows the process powder to be distributed by the powder coater to be emptied along the coater axis in front of and/or behind the powder coater. The powder coater can thus distribute the process powder particularly easily by moving along the coater axis.

In a preferred embodiment of the additive manufacturing device, the dosing device is designed for emptying the powder container above the powder coater. This emptying above the powder container is achieved in a particularly simple manner under the influence of gravity. This eliminates the need for alternative technical means for supplying the process powder, such as a lifting device for feeding process powder from below.

In a preferred further development of an embodiment of the additive manufacturing device, the powder coater has a discharge channel. In a preferred embodiment, the discharge channel is formed by the powder coater. In a further preferred embodiment, the discharge channel is designed to receive the powder container during movement in the process chamber. A discharge channel can thus provide effective protection against a process flow within the process chamber. This prevents the process powder from being scattered or blown out of the powder container by the process flow.

The underlying advantages can also be achieved by a dosing method. The dosing method is suitable, in particular designed, for conveying process powder into the additive manufacturing device described above and below. An embodiment of the dosing method has the following method steps:
In a first method step, the powder container is filled with process powder. In other words, the process powder is fed to the respective powder cavity via the corresponding powder opening. In this regard, the one or more powder openings of the corresponding powder cavity are typically directed upwards in the vertical direction.
In a preferred embodiment, all powder containers are filled with process powder. The powder containers can be filled one after the other. In a preferred embodiment, the powder containers are filled outside of the process chamber, which means that the additive manufacturing method inside the process chamber is not affected.
In a further method step, the powder container is moved through the process chamber opening along a conveying axis into the process chamber.
In a preferred embodiment, the guide carriage is set in motion along the container guide by means of a longitudinal drive, whereby the powder containers arranged on the guide carriage are guided into the process chamber in the conveying direction.
In one method step, the at least one powder cavity of at least one powder container is emptied by rotating the powder container about the container rotation axis. All powder cavities, in particular of all powder containers, may be emptied at the same time.
A further method step involves moving the powder container along the conveying axis out of the process chamber. In other words, the dosing device is moved back to the starting position and the dosing method can be carried out again.
In a preferred embodiment of the dosing method, the filling of the powder container is carried out while measuring the weight of the process powder contained in the powder container. This allows the powder quantity required at the powder coater 24 to be dosed in a precise manner.

Further features and advantages of the invention can be found in the description, the claims, and the drawing. According to the invention, the features mentioned above and those yet to be explained further can be used in each case individually or together in any desired expedient combinations. The embodiments shown and described should not be understood as an exhaustive list, but rather are of an exemplary character for describing the invention.

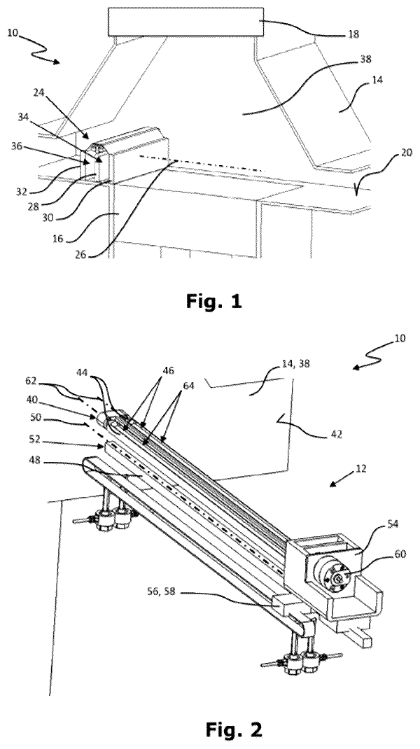

FIG. 1 shows an additive manufacturing device 10 according to the invention with a dosing device 12 (see FIG. 2) and a process chamber 14.

A working cylinder 16 can be arranged in the process chamber 14, in which a workpiece can be manufactured using an additive manufacturing method, for example a powder-bed-based laser metal fusion (LMF) method. According to the exemplary manufacturing method, process powder can be fed to the process chamber 14 or the working cylinder 16, wherein a workpiece can be manufactured in layers by melting the process powder. The additive manufacturing device 10 can have a laser beam unit 18 for this purpose, which—as shown schematically—can be arranged on the outer side of the process chamber 14.

During the manufacture of the workpiece, the working cylinder 16 can be lowered in stages starting from a working plane 20. Each time the working cylinder 16 is lowered, a working trough is created above the working cylinder 16 relative to the working plane 20, which can be filled with process powder by a powder coater 24. For this purpose, the powder coater 24 can be moved in a translational manner along the working plane 20 above the working cylinder 16, along a coater axis 26. The working cylinder 16 filled with the process powder can then be irradiated by the laser beam unit 18, whereby the process powder can be at least partially melted in accordance with the workpiece to be manufactured. Once irradiation by the laser beam unit 18 has been completed, the working cylinder 16 can be lowered again and the method can be repeated until the workpiece is manufactured in its entirety.

The powder coater 24 typically has a wiping lip 28. The wiping lip 28 is typically in permanent contact with the working plane 20. However, the wiping lip 28 can also have a defined distance, for example 1 millimeter, from the working plane 20 in order to be able to compensate for unevenness in a process chamber floor. The wiping lip 28 can distribute process powder evenly in the working trough. Furthermore, the wiping lip 28 can remove excess process powder from the working cylinder 16 so that a powder layer flush with the working plane 20 or parallel to the working plane 20 is formed in the working cylinder 16 or the process chamber. The wiping lip 28 is, in a preferred embodiment, formed from an elastomer. This means that the wiping and spreading functions can be carried out by the wiping lip 28 in a particularly reliable manner.

As shown, the powder coater 24 may include a first wind deflector 30 and a second wind deflector 32. Typically, a first process powder room 34 is formed between the first wind deflector 30 and the wiping lip 28 and a second process powder room 36 is formed between the second wind deflector 32 and the wiping lip 28 on the powder coater 24. The first process powder room 34 and the second process powder room 36 are used to feed the process powder on the basis of the direction of movement of the powder coater 24 in front of the wiping lip 28. For example, process powder can be supplied to the powder coater in the first process powder room 34 according to the position shown in FIG. 1. By moving the powder coater 24, the process powder provided in the first process powder room 34 can be distributed over the working cylinder 16 until a powder layer formed flush with the working plane 20 is formed.

The second process powder room 36 may be provided for forming a flush powder layer when the powder coater 24 is moved in an opposite direction along the coater axis 26. In a preferred embodiment, the second process powder room 36 is filled simultaneously with the first process powder room 34 or immediately after the first process powder room 34 is filled with process powder. In a particularly preferred embodiment, at least the second process powder room 36 has a retaining means that can prevent discharge of the process powder.

The first and second wind deflectors 30, 32, in a preferred embodiment, prevent process powder from being blown out by process flows within the process chamber 14.

The process chamber 12 typically has a process chamber wall 38. The process chamber wall 38, in a preferred embodiment, completely surrounds the process chamber 12 and forms a process chamber volume.

FIG. 2 shows the additive manufacturing device 10 in a view of the outer side of the process chamber 14, or the process chamber wall 38.

As shown, the process chamber 14 has a process chamber opening 40 formed on the process chamber wall 38. In the embodiment shown, the process chamber opening 40 can be closed by the dosing device 12. In the present case, a closable process chamber opening 40 is to be understood as a gas-tight abutment of the dosing device 12 against the process chamber wall 38.

The dosing device 12 is arranged on the outer side 42 of the process chamber 14.

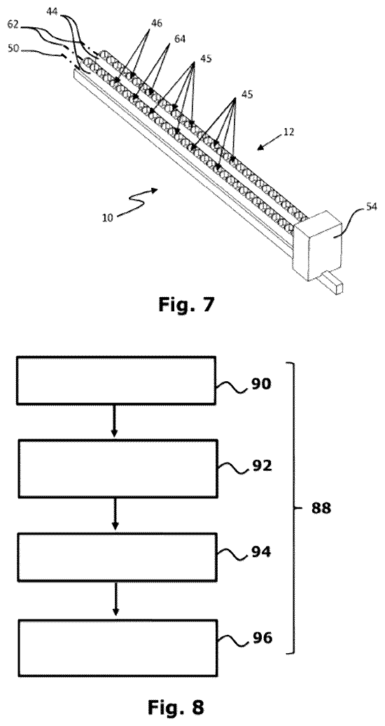

The dosing device 12—as shown—can have two powder containers 44. The powder containers 44 each have at least one powder cavity 46, which is designed to receive the process powder. The powder cavity of a powder container can be divided into two or more segments 47 by means of separators 45 (see FIG. 7).

The dosing device 12 further has a container guide 48. The container guide 48 is designed to move at least one powder container 44 in a straight line along a conveying axis 50 of the dosing device 12. In a preferred embodiment, the length of the container guide 48 corresponds to a penetration depth of the powder containers 44 into the process chamber 14.

The container guide 48 is arranged with a guide end 52 on the process chamber 14, or the outer side 42 of the process chamber wall 38. The powder containers 44 are typically arranged parallel to the container guide 48. By moving the powder containers 44 along or parallel to the conveying axis 52, the powder containers 44 can be introduced into the process chamber 14 through the closable process chamber opening 40. In this regard, the powder containers 44 can be deflected beyond the guide end 52 of the container guide 48. In other words, the powder containers 44 are arranged on the container guide 48 such that they can be telescoped or pushed apart.

According to the embodiment shown, the powder containers 44 can be arranged on a guide carriage 54. The guide carriage 54 is, in a preferred embodiment, movably arranged on the container guide 48.

The dosing device 12 can have a longitudinal drive 56. The longitudinal drive 56 is typically designed to move the powder container 44 or the guide carriage 54 along the conveying axis 50. As shown, the longitudinal drive 56 can be designed as a belt drive 58.

The dosing device 12 can alternatively or additionally have a rotary drive 60. The rotary drive 60 can be designed to rotate the powder container 44 about a container rotation axis 62. In a preferred embodiment, each powder container 44 has its own container rotation axis 62. In a particularly preferred embodiment, the powder containers 44 are designed to be rotatable independently of one another by the rotary drive 60.

The rotary drive 60 is, in a preferred embodiment, designed as an actuator and for transmitting at least half a revolution, in a particularly preferred embodiment a full revolution, to the powder containers 44. In other words, each powder container 44 can be rotated about its respective container rotation axis 62 such that the respective powder cavity 46 can be moved from a vertically upwardly directed position to a vertically downwardly directed position.

Typically, the powder cavities 46 each have a powder opening 64, in particular exclusively one powder opening. The powder containers 44 or the powder cavities 46 can thus advantageously be filled in the direction of gravity, while the powder containers 44 with the respective powder opening 64 are in a vertically upwardly directed position. The powder containers 44 or the powder cavities 46 can also advantageously be emptied in the direction of gravity, while the powder containers 44 with their respective powder opening 64 are in a vertically downwardly directed position.

FIG. 2 shows the dosing device 12 in an undeflected state. In other words, as shown in FIG. 2, the dosing device 12 is located completely outside of the process chamber 14.

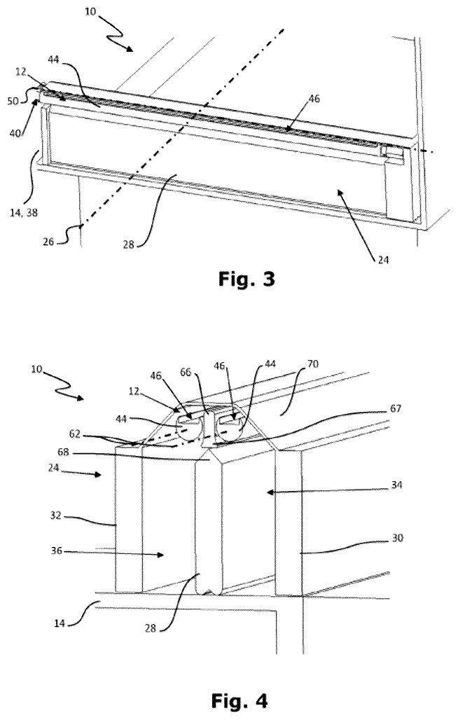

FIG. 3 shows a detailed sectional view of the additive manufacturing device 10. The dosing device 12 is in a deflected state. In other words, the powder containers 44 are deflected along the conveying axis 50 such that the powder containers 44 are located completely within the process chamber 14. In this regard, the powder containers 44 were guided parallel to the container guide 48 (see FIG. 2) along the conveying axis 50 through the process chamber opening 40. As shown, the conveying axis 50 can be situated perpendicular to the coater axis 26.

The powder containers 44, in particular the powder cavities 46, in a preferred embodiment, have the same dimensions along the conveying direction 50 as the powder coater 24, in particular the wiping lip 28. This allows powder to be fed over the entire extension of the powder coater 24. Typically, the extension of the powder coater 24 is adapted to a dimension of the working cylinder 16 (see FIG. 1) perpendicular to the coater axis 26, whereby the process powder can be distributed particularly effectively in the working cylinder 16 (see FIG. 1).

FIG. 4 shows a further detailed sectional view of the additive manufacturing device 10, wherein in particular the powder coater 24 is shown. The dosing device 12 is partially arranged in the process chamber 14 of the additive manufacturing device 10 by the powder containers 44.

According to the embodiment shown, the powder containers 44 can be arranged above the wiping lip 28 of the powder coater 24. In a preferred embodiment, the powder containers 44 are arranged centrally above the wiping lip 28. If the dosing device 12 has only one powder container 44, it can be arranged centrally above the wiping lip 28.

In a particularly preferred embodiment, one powder container 44 is arranged above the first process powder room 34 and another powder container 44 is arranged above the second process powder room 36. This allows the process powder to be fed to both sides of the wiping lip 28.

As shown, the dosing device 12 can have a container holder 66. The container holder 66 is, in a preferred embodiment, designed to support the powder container 44. This can prevent the powder container 44 from bending. Furthermore, the container holder 66 can effectively prevent process powder from inadvertently reaching the side of the wiping lip 28 facing away from the powder container 44. For this purpose, the container holder 66 can have a foot section 67 that widens in the vertical direction. Alternatively or additionally, the wiping lip 28 can have a head section 68 tapering in the vertical direction, which prevents process powder from reaching the other side of the wiping lip 28 during emptying.

According to the embodiment shown, each powder container 44 can be rotated about its container rotation axis 62, wherein the corresponding powder cavity 46 with the corresponding powder opening 64 is moved from a vertically upwardly directed position to a vertically downwardly directed position. The process powder contained in the respective powder cavity 46 can be emptied by rotation to the corresponding side of the wiping lip 28.

In a specific embodiment of the additive manufacturing device 10, the powder coater 24 has a discharge channel 70. In a preferred embodiment, the discharge channel 70 can be formed on the powder coater 24. The discharge channel 70 is designed to receive the dosing device 12 or the powder container 44 within the process chamber 14. In other words, the discharge channel 70 provides an enclosure for the powder containers 44. The powder containers 44 are movable within the discharge channel 70. The discharge channel 70 can prevent a process flow formed within the process chamber 14 from carrying away or entraining the process powder carried in the process containers 44.

In a particularly preferred embodiment, the discharge channel 70 is formed between the first and the second wind deflector 30, 32. In this way, effective protection against a flow-related removal of the process powder by the process flow can be achieved even after the process powder has been emptied from the powder cavities 46.

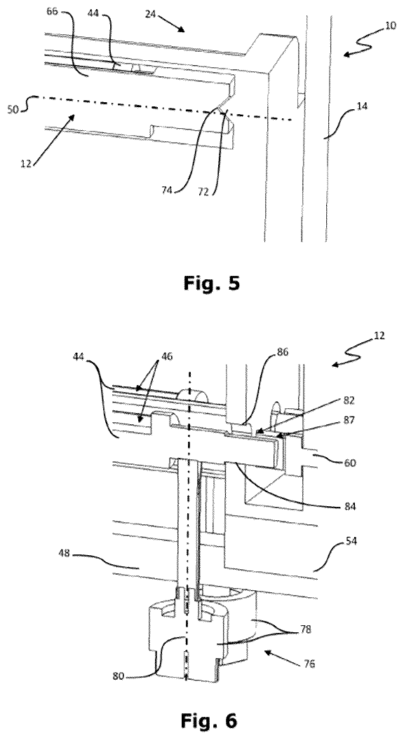

FIG. 5 shows a further detailed sectional view of the powder coater 24 of the additive manufacturing device 10. The powder containers 44 of the dosing device 12 are arranged in the process chamber 14.

As shown, the powder coater 24 can have or form a centering section 72. The centering section 72 is typically formed on a side of the powder coater 24 facing away from the process chamber opening 40 (see FIG. 3). The centering section 72, in a preferred embodiment, protrudes along the conveying axis 50 in the direction of the dosing device 12. The dosing device 12—in this case the container holder 66—forms a centering recess 74 complementary to the centering section 72 and/or a complementary centering projection in a preferred embodiment. The centering section 72 is formed in conjunction with the centering recess 74 for centering the dosing device 12 or the powder container 44 within the process chamber 14. According to the embodiment shown, the powder containers 44 are supported against the powder coater 24 by means of the container holder 66 when fully inserted into the process chamber 14. This can prevent the powder container 44 from bending even more effectively.

FIG. 6 shows a detailed sectional view of the dosing device 12.

The dosing device 12 has the container guide 48 and the powder containers 44 arranged on the container guide 48 via the guide carriage 54.

In a preferred embodiment, the dosing device 12 can—as shown—have a weighing unit 76. The weighing unit 76 is designed to determine the process powder contained in the powder containers 44 or in the powder cavities 46.

For this purpose, the weighing unit 76 can be designed to weigh each individual powder container 44. Typically, the weighing unit 76 has at least one measuring sensor 78, in a particularly preferred embodiment two measuring sensors 78 per powder container 44 (see also FIG. 2).

According to the embodiment shown, the weighing unit 76, or each individual measuring sensor 78, can be designed to be movable along a measuring axis 80 in the vertical direction. In other words, the weighing unit 76 can be moved in the vertical direction towards the powder containers 44. This allows only temporary contact of the weighing unit 76 with the powder containers 44. In other words, the weighing unit 76 can be moved out of a range of motion of the powder containers 44 and/or the guide carriage 54 after measurement has been completed, thereby preventing a collision. The weighing unit 76 can be moved along the measuring axis 80, for example, by means of corresponding actuators.

In order to weigh the respective powder container 44, the measuring sensor 78 is first moved along the measuring axis 80 in the direction of the powder container 44 until the measuring sensor 78 is in contact with the powder container 44. A contact of the measuring sensor 78 with the powder container 44 can be established, for example, by applying force to the measuring sensor 78. Subsequently, the powder container 44 can be lifted along the measuring axis 80 by the measuring sensor 44. In other words, the powder container 44 is detached from the rest of the dosing device 12 in the vertical direction. This enables the exclusive weight measurement of the powder container 44 including the process powder contained therein.

In order to enable the powder container 44 to be lifted, the dosing device 12 typically has a floating bearing arrangement 82 in the vertical direction. Starting from a lower vertical stop 84, the floating bearing arrangement 82 only allows relative movement in the vertical direction up to an upper vertical stop 86 in this regard. The floating bearing arrangement 82 typically acts on a rotary coupling 87 between the powder containers 44 and the rotary drive 60 in order to allow the release of the corresponding powder container 44.

After weighing the powder container 44, the weighing unit 76 can be spaced apart from the powder container 44 along the measuring axis 80. As a result, the powder container 44 comes to rest against the lower vertical stop 84.

FIG. 7 shows a further schematic detailed representation of the powder container 44.

In this embodiment, the powder container 44 has a plurality of separators 45 which are introduced into the powder cavity 46. Thus, the powder cavity 46 is divided into multiple segments 47. In this regard, the separators 45 can be distributed evenly and/or unevenly spaced across the powder cavity 46.

FIG. 8 shows a schematic representation of a dosing method 88 according to the invention for conveying process powder into an additive manufacturing device 10 (see FIG. 1). The dosing method 88 has the following method steps, which are explained with reference to the preceding figures:

In a first method step 90, the powder container 44 is filled with process powder. In a preferred embodiment, all powder containers 44 are filled with process powder in the method step 90.

Typically, the powder container 44 is filled under the influence of gravity via the corresponding powder cavity 46 of the powder container 44. For example, the powder containers 44 can be filled by means of a vibrating conveyor ramp. Filling can take place outside of the process chamber 14. In this regard, a powder opening 64 of the corresponding powder cavity 46 is directed upwards in the vertical direction.

In a further method step 92, the powder container 44 filled with process powder is moved through the process chamber opening 40 along the conveying axis 50 into the process chamber 14.

In a preferred embodiment, the guide carriage 54 is set in motion along the container guide 48 by means of a longitudinal drive 56, whereby the powder containers 44 arranged on the guide carriage 54 are guided into the process chamber 14 in the conveying direction 50.

A further method step 94 provides for emptying at least one powder cavity 46 of at least one powder container 44 by rotating the corresponding powder container 44 about its container rotation axis 62.

In this regard, emptying typically takes place into a first powder chamber 34 of the powder coater 24.

In a further method step 96, the powder container 44 is moved along the conveying axis 50 out of the process chamber 14. In other words, the dosing device 12 is moved back to the starting position and the dosing method 88 can be carried out again.

In a preferred embodiment of the dosing method 88, the filling of the powder container 44 can be carried out while measuring the weight of the process powder contained in the powder container 44. This allows the powder quantity required at the powder coater 24 to be dosed in a precise manner.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Manufacturing device 10;
Dosing device 12;
Process chamber 14;
Working cylinder 16;
Laser beam unit 18;
Working plane 20;
Powder coater 24;
Coater axis 26;
Wiping lip 28;
First wind deflector 30;
Second wind deflector 32;
First process powder room 34;
Second process powder room 36;
Process chamber wall 38;
Process chamber opening 40;
Outer side 42;
Powder container 44;
Separator 45;
Powder cavity 46;
Segment 47;
Container guide 48;
Conveying axis 50;
Guide end 52;
Guide carriage 54;
Longitudinal drive 56;
Belt drive 58;
Rotary drive 60;
Container rotation axis 62;
Powder opening 64;
Container holder 66;
Foot section 67;
Head section 68;
Discharge channel 70;
Centering section 72;
Centering recess 74;
Weighing unit 76;
Measuring sensor 78;
Measuring axis 80;
Floating bearing arrangement 82;
Lower vertical stop 84;
Upper vertical stop 86;
Rotary coupling 87;
Dosing method 88;
Method step 90;
Method step 92;
Method step 94;
Method step 96.

1. A dosing device for being arranged on the outside of a process chamber of an additive manufacturing device and for conveying process powder into the process chamber, the dosing device comprising:
at least one powder container comprising at least one powder cavity which is designed to receive the process powder; and
a container guide for moving the powder container in a straight line along a conveying axis of the dosing device,
wherein the powder container is movably arranged on the container guide, and
wherein the powder container is designed to be deflected beyond the container guide along the conveying axis.

2. The dosing device according to claim 1, further comprising a longitudinal drive, wherein the longitudinal drive is designed to move the powder container along the conveying axis.

3. The dosing device according to claim 1, wherein the powder cavity has at least one vertically upwardly directed powder opening that allows the powder container to be filled in the direction of gravity.

4. The dosing device according to claim 1, wherein the powder container is arranged on the container guide in a manner rotatable about a container rotation axis.

5. The dosing device according to claim 4, wherein the container rotation axis is designed to be parallel or congruent to the conveying axis.

6. The dosing device according to claim 4, having a rotary drive, wherein the rotary drive is designed to rotate the powder container about the container rotation axis.

7. The dosing device according to claim 1, wherein the powder container is designed as a hollow shaft.

8. The dosing device according to claim 1, further comprising a weighing unit, wherein the weighing unit is designed to determine the process powder contained in the powder container.

9. The dosing device according to claim 8, wherein the weighing unit has at least one measuring sensor that is designed for weighing the powder container.

10. The dosing device according to claim 9, wherein the measuring sensor is designed for temporary arrangement on a test container in the vertical direction by means of an actuator.

11. The dosing device according to claim 1, comprising at least two powder containers, each comprising at least one powder cavity, wherein the powder containers are arranged parallel to one another.

12. The dosing device according to claim 11, wherein the powder containers are designed to be movable together along the conveying axis.

13. The dosing device according to claim 1, wherein the at least one powder cavity is divided into two or more segments, and wherein the segments are arranged at a uniform distance from one another.

14. An additive manufacturing device for the additive manufacture of at least one workpiece in layers from a process powder by means of region-by-region solidification of the process powder in a process chamber, comprising the dosing device according to claim 1,
wherein the process chamber has at least one closable process chamber opening,
wherein the dosing device is arranged on an outer side of the process chamber, and
wherein the dosing device is designed to move the powder container along the conveying axis through the closable process chamber opening into the process chamber.

15. The additive manufacturing device according to claim 14, further comprising:
a working cylinder arranged in the process chamber, wherein the process chamber is designed for manufacturing the workpiece within the working cylinder; and
a powder coater for distributing the process powder in the working cylinder,
wherein the powder coater is designed to be movable along a coater axis above the working cylinder, and
wherein the coater axis runs perpendicular to the conveying axis.

16. The additive manufacturing device according to claim 15, wherein the dosing device is designed for emptying the powder container above the powder coater.

17. The additive manufacturing device according to claim 15, wherein the powder coater forms a discharge channel, and wherein the powder container in the process chamber is designed to be movable within a discharge channel.

18. A dosing method for conveying process powder into the process chamber of the additive manufacturing device according to claim 14, comprising the method steps of:
filling the powder container with process powder;
moving the powder container through the process chamber opening along the conveying axis into the process chamber;
emptying the powder cavity by rotating the powder container about the container rotation axis; and
moving the powder container along the conveying axis out of the process chamber.

19. The dosing method according to claim 18, wherein the filling of the powder container is carried out while measuring the weight of the process powder contained in the powder container.
